(19) United States
(12) Patent Application Publication
(10) Pub. No.: US 2012/0255531 A1
(43) Pub. Date: Oct. 11, 2012

(54) INTER-CYLINDER AIR/FUEL RATIO IMBALANCE ABNORMALITY DETECTION APPARATUS AND INTER-CYLINDER AIR/FUEL RATIO IMBALANCE ABNORMALITY DETECTION METHOD FOR MULTICYLINDER INTERNAL COMBUSTION ENGINE

(75) Inventor: Kenichi Kinose, Okazaki-shi (JP)

(73) Assignee: TOYOTA JIDOSHA KABUSHIKI KAISHA, Toyota-shi (JP)

(21) Appl. No.: 13/438,022

(22) Filed: Apr. 3, 2012

(30) Foreign Application Priority Data
Apr. 5, 2011 (JP) 2011-083825

(51) Int. Cl. F02D 41/14

(52) U.S. Cl. 123/673

(57) ABSTRACT

An inter-cylinder air/fuel ratio imbalance abnormality detection apparatus for a multicylinder internal combustion engine includes a fuel injection amount change control portion that executes a fuel injection amount change control of forcing a fuel injection amount of a predetermined object cylinder to change by a predetermined amount; an ignition timing retardation control portion that executes an ignition timing retardation control for the predetermined object cylinder; and a detection portion that detects an inter-cylinder air/fuel ratio imbalance abnormality based on output fluctuation regarding the predetermined object cylinder occurring when the fuel injection amount change control and the ignition timing retardation control are executed together for the predetermined object cylinder.

### INCORPORATION BY REFERENCE

The disclosure of Japanese Patent Application No. 2011-083825 filed on Apr. 5, 2011 including the specification, drawings and abstract is incorporated herein by reference in its entirety.

### BACKGROUND OF THE INVENTION

1. Field of the Invention

The invention relates to an apparatus and a method for detecting inter-cylinder imbalance abnormality in the air/fuel ratio in a multicylinder internal combustion engine.

2. Description of Related Art

Generally, with regard to an internal combustion engine equipped with an exhaust gas control system that uses catalysts, in order to efficiently remove pollutants from exhaust gas, it is essential to control the mixing ratio between air and fuel in a mixture that is burned in the internal combustion engine, that is, control the air/fuel ratio. In order to perform the control of the air/fuel ratio, an air/fuel ratio sensor is provided in an exhaust passageway of the internal combustion engine, and a feedback control is performed so that the air/fuel ratio detected by the sensor becomes equal to a predetermined target air/fuel ratio.

Usually, in a multicylinder internal combustion engine, the air/fuel ratio control is performed by using the same control amount for all the cylinders; therefore, despite of execution of the air/fuel ratio control, the actual air/fuel ratio sometimes varies among the cylinders. In such a case, if the degree of variation (imbalance) in the air/fuel ratio is small, the variation in the air/fuel ratio can be absorbed by the feedback control of the air/fuel ratio and pollutants in exhaust gas can be removed by the catalysts. Thus, the variation in the air/fuel ratio does not affect the exhaust emission, and does not cause any particular problem.

However, if the air/fuel ratio greatly varies among the cylinders due to, for example, failure of the fuel injection systems of one or more cylinders or the valve actuation mechanism of the intake valves, the exhaust emission may deteriorate, and problems may arise. It is desirable that such a large variation in the air/fuel ratio that deteriorates the exhaust emission be detected as an abnormality. Particularly, in the case of the internal combustion engines for use in motor vehicles, in order to prevent a vehicle from traveling with deteriorated exhaust emission, a technology of detecting inter-cylinder air/fuel ratio imbalance abnormality in a vehicle-mounted engine (so-called on-board diagnostics (OBD)) has been developed, and has been legally required in the United States.

For example, Japanese Patent Application Publication No. 7-279732 (JP 7-279732 A) discloses that fluctuations in the revolution of a multicylinder internal combustion engine that occur during operation of the engine at an air/fuel ratio leaner than the stoichiometric air/fuel ratio are detected for each cylinder, and the amount of fuel injection is changed on the basis of the detected revolution fluctuations, and then an inter-cylinder imbalance in the air/fuel ratio is detected on the basis of the amount of change in the fuel injection amount.

When a multicylinder internal combustion engine has the inter-cylinder air/fuel ratio imbalance abnormality, the variation in output among the cylinders may become large. In order to more reliably detect such output fluctuation, it may be effective to forcibly change the fuel injection amount. However, if the amount of change in the fuel injection amount is excessively increased to improve the detection accuracy, there is possibility of deterioration of drivability and deterioration of exhaust emission.

### SUMMARY OF THE INVENTION

The invention more appropriately detects the inter-cylinder air/fuel ratio imbalance abnormality in a multicylinder internal combustion engine while restraining deterioration of drivability and deterioration of exhaust emission.

An inter-cylinder air/fuel ratio imbalance abnormality detection apparatus for a multicylinder internal combustion engine according to an aspect of the invention includes: a fuel injection amount change control portion that executes a fuel injection amount change control of forcing a fuel injection amount of a predetermined object cylinder to change by a predetermined amount; an ignition timing retardation control portion that executes an ignition timing retardation control for the predetermined object cylinder; and a detection portion that detects an inter-cylinder air/fuel ratio imbalance abnormality based on output fluctuation regarding the predetermined object cylinder occurring when the fuel injection amount change control and the ignition timing retardation control are executed together for the predetermined object cylinder.

The fuel injection amount change control portion may execute the fuel injection amount change control so that the fuel injection amount of the predetermined object cylinder is increased or decreased from a usual-time fuel injection amount by the predetermined amount.

The detection portion may detect the inter-cylinder air/fuel ratio imbalance abnormality based on revolution fluctuation regarding the predetermined object cylinder occurring when the fuel injection amount change control and the ignition timing retardation control are executed together for the predetermined object cylinder.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram of an internal combustion engine in accordance with a first embodiment of the invention;

FIG. 2 is a graph showing output characteristics of a pre-catalyst sensor and a post-catalyst sensor;

FIG. 3 is a time chart for describing a value that represents revolution fluctuation;

FIG. 4 is a time chart for another value that represents revolution fluctuation;

FIG. 5 is a graph conceptually representing a relation between the imbalance rate of an object cylinder and the amount of revolution fluctuation;

FIG. 6 is a graph that represents a portion of the characteristic curve shown in FIG. 5, and that is presented for describing the relationship between the amount of increase of the fuel injection amount and the change in the amount of revolution fluctuation from before to after the increase of the fuel injection amount;

FIG. 7 is a graph representing a characteristic curve, together with the characteristic shown in FIG. 6, for describing a relation of retardation of the ignition timing to the increase in the fuel injection amount and change in the amount of revolution fluctuation between before and after the increase in the fuel injection amount;

FIG. 8 is a diagram for describing the flow of a control in the first embodiment; and

FIG. 9 is a diagram for describing the flow of a control in a second embodiment.

### DETAILED DESCRIPTION OF EMBODIMENTS

Embodiments of the invention will be described hereinafter with reference to the accompanying drawings. Firstly, a first embodiment of the invention will be described.

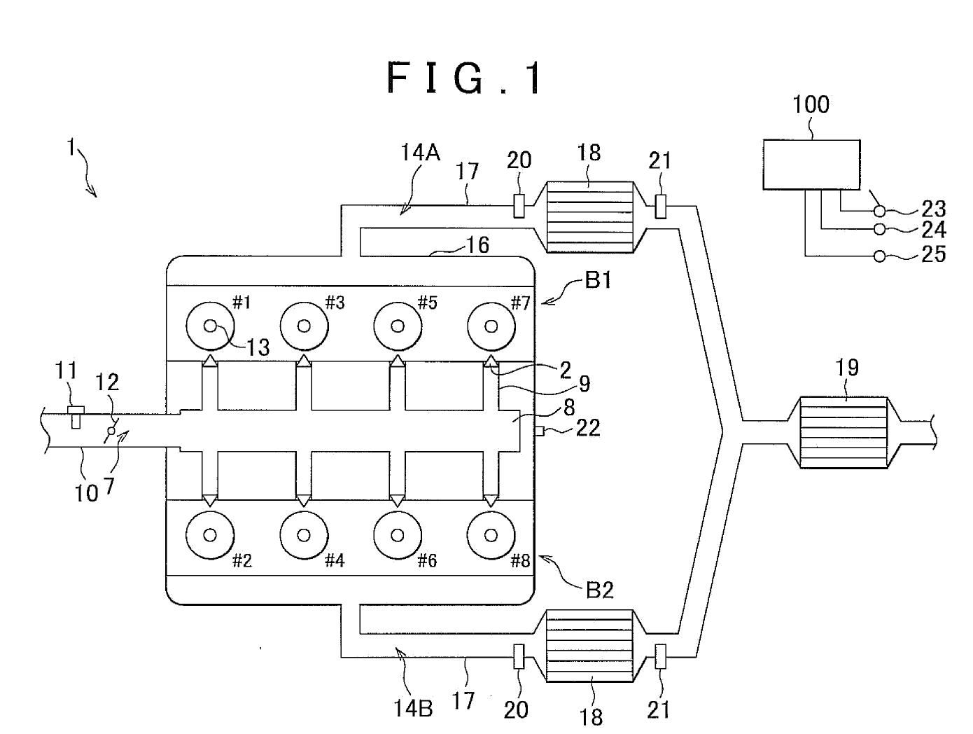

FIG. 1 schematically shows an internal combustion engine in accordance with the first embodiment. An internal combustion engine (engine) 1 shown in FIG. 1 is a V-type eight-cylinder spark ignition internal combustion engine (gasoline engine). The engine 1 has a first bank 131 and a second bank B2. The first bank B1 is provided with odd-numbered cylinders, that is, #1, #3, #5 and #7 cylinders, and the second bank B2 is provided with even-numbered cylinders, that is, #2, #4, #6 and #8 cylinders. The #1, #3, #5 and #7 cylinders make up a first cylinder group, and the #2, #4, #6 and #8 cylinders make up a second cylinder group.

Each cylinder is provided with an injector (fuel injection valve) 2 as a fuel injection portion. Each injector 2 injects fuel into an intake passageway of a corresponding one of the cylinders and, particularly, to an intake port (not shown) thereof. Each cylinder is also provided with an ignition plug 13 as an ignition portion for igniting a mixture in the cylinder. The ignition order in the engine 1 is the order of the #1, #8, #7, #3, #6, #5, #4 and #2 cylinders.

An intake passageway 7 for introducing intake gas into the cylinders is formed by the intake ports, a surge tank 8 as a collection portion, a plurality of intake manifolds 9 that connect the intake ports of the cylinders and the surge tank 8, an intake pipe 10 provided on an upstream side of the surge tank 8, etc. A portion of the intake passageway 7 at the upstream side of the surge tank 8 is provided with an air flow meter 11 and an electronically controlled throttle valve 12 in that order from the upstream side. The air flow meter 11 outputs a signal whose magnitude corresponds to the amount of flow of intake gas. An upstream end-side portion of the intake passageway 7 is provided with an air cleaner (not shown) for removing dust, dirt, etc. from the air introduced into the intake passageway 7.

A first exhaust passageway 14A is provided for the first bank B1, and a second exhaust passageway 14B is provided for the second bank B2. The first and second exhaust passageways 14A and 14B join to form a single exhaust passageway, at the upstream side of a downstream catalytic converter 19. The constructions of the exhaust systems of the two banks at the upstream side of the junction position are the same. Therefore, description will be made only for the first bank B1-side construction, and the second bank B2-side construction will not be described while in FIG. 1, like components and portions of the two systems are denoted by like reference characters.

A portion of the first exhaust passageway 14A at the upstream side of the junction position is formed by exhaust ports (not shown) of the #1, #3, #5 and #7 cylinders, exhaust manifolds 16 that collect exhaust gas from the exhaust ports, an exhaust pipe 17 disposed on the downstream side of the exhaust manifolds 16. A portion of the exhaust pipe 17 is provided with an upstream catalytic converter 18. At the upstream side and the downstream side of (immediately upstream and immediately downstream of) the upstream catalytic converter 18, there are disposed a pre-catalyst sensor 20 and a post-catalyst sensor 21 that are air/fuel ratio detection portions for detecting the air/fuel ratio of exhaust gas. Thus, for the plurality of cylinders (or the cylinder group) that belong to one of the two banks, there are provided one upstream catalytic converter 18, one pre-catalyst sensor 20 and one post-catalyst sensor 21. It is also possible to provide the first and second exhaust passageways 14A and 14B that are not joined to each other, and provide a downstream catalytic converter 19 separately for each of the first and second exhaust passageways 14A and 14B.

The engine 1 is provided with an electronic control unit (hereinafter, termed the ECU) 100 that performs various functions as various control portions (control devices) and various detection portions. The ECU 100 includes a CPU, storage devices that include a ROM and a RAM, an input/output port, etc. none of which is shown in the drawings. The ECU 100 is electrically connected with the air flow meter 11, the pre-catalyst sensors 20 and the post-catalyst sensors 21, and also with a crank angle sensor 22 for detecting the crank angle of the engine 1, an accelerator operation amount sensor 23 for detecting the accelerator operation amount, a coolant temperature sensor 24 for detecting the temperature of an engine coolant, a knock sensor 25 for detecting occurrence of knocking, and other various sensors, via A/D converters or the like. On the basis of detected values or the like from the various sensors, the ECU 100 controls the injectors 2, the ignition plugs 13, the throttle valve 12, etc., to control the fuel injection amount, the fuel injection timing, the ignition timing, the degree of throttle opening, etc., so that a desired engine output is obtained.

Thus, the ECU 100 performs functions of a fuel injection control portion, an ignition control portion, an intake air amount control portion, and an air/fuel ratio control portion constructed as a combination of the foregoing control portions, etc. More specifically, the engine 1 is equipped with an inter-cylinder air/fuel ratio imbalance abnormality detection apparatus as described later, and the ECU 100 performs functions of a fuel injection amount change control portion, an ignition timing retardation control portion, and a detection portion that detects the presence or absence of inter-cylinder air/fuel ratio imbalance abnormality. In this embodiment, the detection portion includes an output fluctuation amount detection portion for detecting a certain value that represents fluctuation in the output of the engine 1 (output fluctuation amount), and a comparison portion that compares the output fluctuation amount detected by the output fluctuation amount detection portion with a predetermined value.

The throttle valve 12 is provided with a throttle opening degree sensor (not shown), and an output signal of the throttle opening degree sensor is sent to the ECU 100. Usually, the ECU 100 controls, through feedback, the degree of opening of the throttle valve 12 (throttle opening degree) to a degree of opening that is determined according to the accelerator operation amount.

Besides, on the basis of an output signal of the air flow meter 11, the ECU 100 detects the amount of intake air per unit time, that is, the intake air amount. Then, the ECU 100 detects the load on the engine 1 on the basis of at least one of the detected accelerator operation amount, the detected throttle opening degree and the detected intake air amount.

The ECU 100, on the basis of a crank pulse signal from the crank angle sensor 22, detects the crank angle, and also detects the number of revolutions of the engine 1. It is to be noted herein that the “number of revolutions” refers to the number of revolutions per unit time, and means the same as revolution speed. In this embodiment, the number of revolutions refers to the number of revolutions per minute (rpm). In the ECU 100, a portion that substantially functions as the detection portion that detects the inter-cylinder air/fuel ratio imbalance abnormality detects a value (revolution fluctuation amount) that represents engine revolution fluctuation as an output fluctuation amount on the basis of the output of the crank angle sensor 22 provided as an output detection portion.

Besides, the ECU 100 performs an ignition timing correction control with respect to a reference ignition timing that is determined on the basis of a state of engine operation, for example, the engine revolution speed and the engine load. The ECU 100 controls the operation of the ignition plugs 13 on the basis of the output of the knock sensor 25 so that the ignition timing approaches an ignition timing (MBT) at which the engine 1 produces a maximum torque and so that occurrence of knocking is avoided. That is, the engine 1 is equipped with a knock control system (KCS) such that the ignition timing is controlled to the vicinity of a knock limit. The ignition timing is subjected to a correction control so that if it is determined that there is knocking on the basis of the output of the knock sensor 25, the ignition timing is retarded, and so that if it is determined that knocking is not present, the ignition timing is advanced.

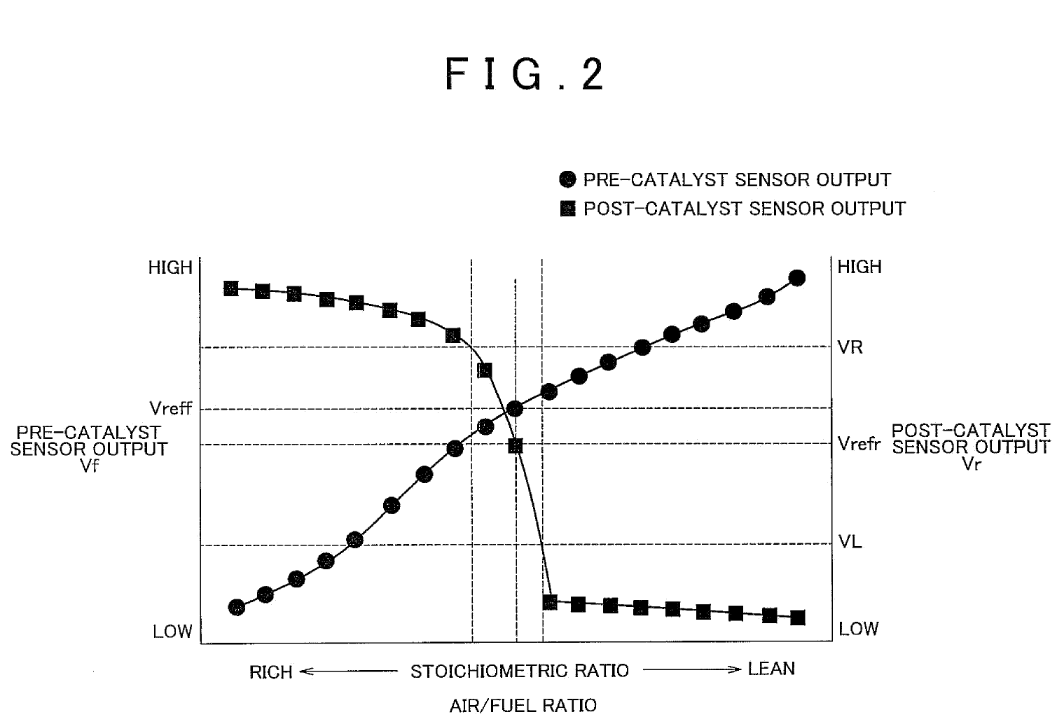

The pre-catalyst sensor 20, which is an air/fuel ratio sensor, is formed by a so-called wide-range air/fuel ratio sensor, and is capable of continuously detecting the air/fuel ratio over a relatively wide range. FIG. 2 shows an output characteristic of the pre-catalyst sensor 20. As shown in FIG. 2, the pre-catalyst sensor 20 outputs a voltage signal Vf whose magnitude is proportional to the exhaust air/fuel ratio (pre-catalyst air/fuel ratio A/Ff) that the pre-catalyst sensor 20 detects. The output voltage that the pre-catalyst sensor 20 produces when the exhaust air/fuel ratio is stoichiometric (i.e., the stoichiometric air/fuel ratio, for example, A/F=14.5) is Vreff (e.g., about 3.3 V).

On the other hand, the post-catalyst sensor 21, which is also an air/fuel ratio sensor, is formed by a so-called O₂ sensor, and has a characteristic in which the output value of the sensor changes sharply in the vicinity of the stoichiometric ratio. FIG. 2 also shows an output characteristic of the post-catalyst sensor 21. As shown in FIG. 2, the output voltage that the post-catalyst sensor 21 produces when the exhaust air/fuel ratio (post-catalyst air/fuel ratio A/Fr) is stoichiometric, that is, a stoichiometric ratio-equivalent voltage value, is Vrefr (e.g., 0.45 V). The output voltage of the post-catalyst sensor 21 changes within a predetermined range (e.g., a range of 0 to 1 V). Generally, when the exhaust air/fuel ratio is leaner than the stoichiometric ratio, the output voltage Vr of the post-catalyst sensor is lower than the value Vrefr that corresponds to the stoichiometric ratio, and when the exhaust air/fuel ratio is richer than the stoichiometric ratio, the output voltage Vr of the post-catalyst sensor is higher than the stoichiometric ratio-corresponding value Vrefr. The post-catalyst sensor 21 can be omitted.

Each of the upstream catalytic converter 18 and the downstream catalytic converter 19 includes a three-way catalyst, and therefore has a function of simultaneously removing NOx, HC and CO, which are pollutants in exhaust gas, when the air/fuel ratios A/F of the exhaust gas that flows into the converters are in the vicinity of the stoichiometric ratio. The range (window) of the air/fuel ratio in which the three pollutants can be simultaneously removed with high efficiency is relatively narrow.

Therefore, during usual operation of the engine 1, an air/fuel ratio control (stoichiometric control) for controlling the air/fuel ratio of the exhaust gas that flows into the upstream catalytic converter 18 to the vicinity of the stoichiometric ratio is executed by the ECU 100. The air/fuel ratio control includes a main air/fuel ratio control (main air/fuel ratio feedback control) of controlling, through feedback, the air/fuel ratio of a mixture (concretely, the amount of fuel injection) so that the exhaust air/fuel ratio detected by the pre-catalyst sensor 20 becomes equal to the stoichiometric ratio, which is a predetermined target air/fuel ratio, and a subsidiary air/fuel ratio control (subsidiary air/fuel ratio feedback control) of controlling, through feedback, the air/fuel ratio of the mixture (concretely, the amount of fuel injection) so that the exhaust air/fuel ratio detected by the post-catalyst sensor 21 becomes equal to the stoichiometric ratio.

Thus, in this embodiment, a reference value (target value) of the air/fuel ratio is the stoichiometric ratio, and the fuel injection amount that corresponds to the stoichiometric ratio (referred to as the stoichiometric ratio-corresponding amount) is a reference value (target value) of the fuel injection amount. However, the reference values for the air/fuel ratio and the fuel injection amount may be other values.

The air/fuel ratio control is performed in the unit of bank, or separately for each bank. For example, the detected values from the pre-catalyst sensor 20 and the post-catalyst sensor 21 on the first bank B1 side are used only for the air/fuel ratio feedback control for the cylinders of #1, #3, #5 and #7 that belong to the first bank 131, and are not used for the air/fuel ratio feedback control for the cylinders of #2, #4, #6 and #8 that belong to the second bank B2. The opposite is true as well. That is, the air/fuel ratio control is executed as if there were two independent in-line four-cylinder engines. Besides, in the air/fuel ratio control, the same control amount is uniformly used for all the cylinders that belong to the same bank.

For example, there may occur an event in which at least one of the cylinders (in particular, just one cylinder) has a failure of the injector 2 or the like and therefore a variation (imbalance) in the air/fuel ratio among the cylinders occurs. An example of the event is a case where, in one of the banks, for example, the first bank B1, the fuel injection amount of the #1 cylinder becomes larger than the fuel injection amount of each of the #3, #5 and #7 cylinders due to the improper valve closure of the injector 2 of the #1 cylinder, and therefore the air/fuel ratio of the #1 cylinder deviates further to the rich side than the air/fuel ratio of the #3, #5 and #7 cylinders.

Even in this case, the air/fuel ratio of a total gas supplied to the pre-catalyst sensor 20 (the exhaust gas after the confluence of the flows from the cylinders) may be controlled to the stoichiometric ratio if a relatively large correction amount is given by the aforementioned air/fuel ratio feedback control. However, in view of the individual cylinders, the air/fuel ratio of the #1 cylinder is greatly richer than the stoichiometric ratio, and the air/fuel ratio of each of the #3, #5 and #7 cylinders is leaner than the stoichiometric ratio, and as a result, the air/fuel ratio of the total gas is equal to the stoichiometric ratio. It is apparent that this situation is not desirable in terms of exhaust emission. Therefore, in this embodiment, an apparatus that detects such inter-cylinder air/fuel ratio imbalance abnormality is provided.

Herein, a value termed imbalance rate is used as an index value that represents the degree of inter-cylinder imbalance in the air/fuel ratio. The imbalance rate shows, in the case where only one of the cylinders has a deviated fuel injection amount, by what percentage the fuel injection amount of the cylinder having the deviated fuel injection amount (imbalance cylinder) is deviated from the fuel injection amount of each of the cylinders that do not have a deviated fuel injection amount (balance cylinders), that is, the reference fuel injection amount. The imbalance rate IB (%) is expressed by IB=(α−β)/β×100, where α is the fuel injection amount of the imbalance cylinder and β is the fuel injection amount of the balance cylinders, that is, the reference fuel injection amount. As the imbalance rate IB is greater, the deviation of the fuel injection amount of the imbalance cylinder with respect to the fuel injection amount of the balance cylinders is greater and the degree of imbalance in the air/fuel ratio is greater.

On another hand, in the embodiment, the fuel injection amount of a predetermined object cylinder is actively increased or decreased, or is forced to increase or decrease, and imbalance abnormality is detected on the basis of at least the revolution fluctuation as the output fluctuation regarding the object cylinder, which occurs after the increase or decrease of the fuel injection amount.

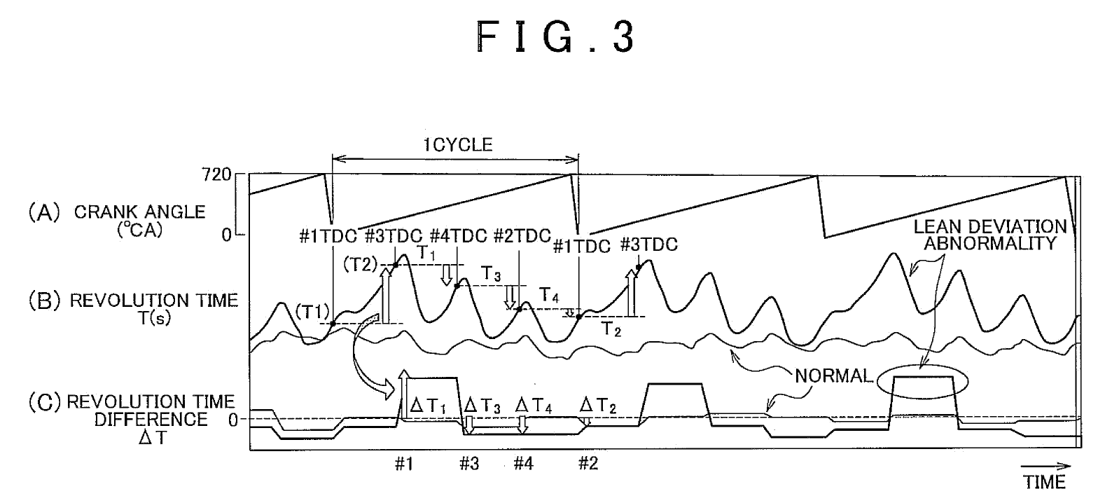

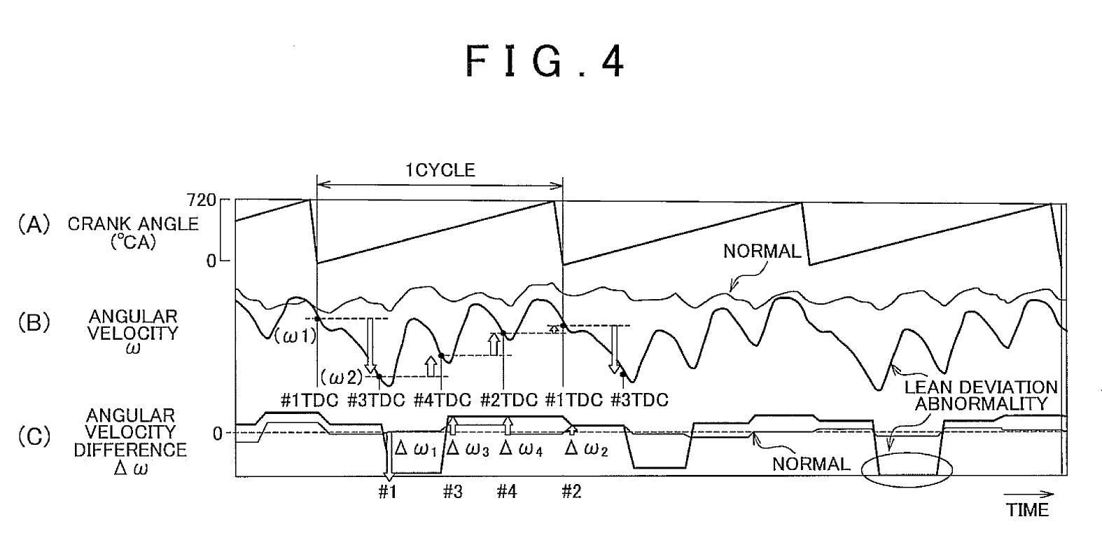

Firstly, the revolution fluctuation will be described. The revolution fluctuation refers to change in the engine revolution speed or the crankshaft revolution speed. In this specification, the value that represents the revolution fluctuation, that is, a value that represents the degree of the revolution fluctuation, is termed the revolution fluctuation amount, as mentioned above. For example, a value (amount) that is obtained by measuring the time needed for the crankshaft to revolve by a predetermined angle and computing the measured value of time, and that represents the magnitude of the measured value or the manner in which the measured value changes may be used as a revolution fluctuation amount. From the following description with reference to FIGS. 3 and 4, it will be apparent that various values may be used as revolution fluctuation amounts.

FIG. 3 shows a time chart as an example that illustrates the revolution fluctuation. Although the example shown in FIG. 3 is the case of an in-line four-cylinder engine, it should be understandable that the illustration is also applicable to a V-type eight-cylinder engine as in the embodiment. In the in-line four-cylinder engine in FIG. 3, the ignition order is the order of the #1, #3, #4 and #2 cylinders.

In FIG. 3, a portion (A) shows the crank angle (° CA) of the engine. One engine cycle is 720 (° CA), and the portion (A) in FIG. 3 shows successively detected crank angles over a plurality of cycles in a saw-tooth form.

A portion (B) in FIG. 3 shows the time needed for the crankshaft to rotate by a predetermined angle, that is, the revolution time T(s). The predetermined angle herein is 30 (° CA), but may also be a different value (e.g., 10 (° CA)). As the revolution time T is longer (i.e., as the point representing the revolution time T is higher in the figure), the engine revolution speed is lower. Conversely, as the revolution time T is shorter, the engine revolution speed is higher. The revolution time T is detected by the ECU 100 on the basis of the output of the crank angle sensor 22.

A portion (C) in FIG. 3 shows a revolution time difference ΔT described later. In FIG. 3, “NORMAL” indicates a normal case where none of the cylinder has air/fuel ratio deviation, and “LEAN DEVIATION ABNORMALITY” shows an abnormal case where only the #1 cylinder has a lean deviation of an imbalance rate IB=−30%. The lean deviation abnormality occurs due to, for example, the clogging of the injection hole of an injector or improper valve opening thereof.

Firstly, the revolution time T of each cylinder at the same timing is detected by the ECU. In this example, the revolution time T at the timing of the compression top dead center (TDC) of each cylinder is detected. The timing at which the revolution time T is detected is termed the detection timing.

At every detection timing, a difference (T2−T1) between the revolution time T2 at the present detection timing and the revolution time T1 at the immediately previous detection timing is calculated. This difference is the revolution time difference ΔT shown in the portion (C) in FIG. 3, that is, ΔT=T2−T1.

Usually, during the combustion stroke after the crank angle exceeds the TDC, the revolution speed rises and therefore the revolution time T decreases, and during the subsequent compression stroke, the revolution speed decreases and therefore the revolution time T increases.

However, as shown in the portion (B) in FIG. 3, if the #1 cylinder has a lean deviation abnormality, ignition in the #1 cylinder does not bring about sufficient torque (output) and therefore the revolution speed does not easily rise, so that the revolution time T at the #3 cylinder's TDC is great. Hence, the revolution time difference ΔT at the #3 cylinder's TDC is a great positive value as shown in the portion (C) in FIG. 3. The revolution time and the revolution time difference at the #3 cylinder's TDC are defined as the revolution time and the revolution time difference of the #1 cylinder, and are represented by T₁ and ΔT₁, respectively. This applies to the other cylinders as well.

Next, when the #3 cylinder is ignited, the revolution speed sharply rises since the #3 cylinder is normal. This results in a slight decrease in the revolution time T at the time of the #4 cylinder's TDC in comparison with the revolution time T detected at the #3 cylinder's TDC. Therefore, the revolution time difference ΔT₃ of the #3 cylinder detected at the #4 cylinder's TDC is a small negative value as shown in the portion (C) in FIG. 3. Thus, at every ignition cylinder's TDC, the revolution time difference ΔT of a cylinder is detected.

After that, a tendency similar to that observed at the #4 cylinder's TDC is observed at the #2 cylinder's TDC and the #1 cylinder's TDC as well, and the revolution time difference ΔT₄ of the #4 cylinder and the revolution time difference ΔT₂ of the #2 cylinder detected at the two TDC timings are both small negative values. The above-described characteristic is repeated every engine cycle.

Thus, it should be understood that the revolution time difference ΔT of each cylinder is a value that represents the revolution fluctuation regarding the cylinder, and that correlates with the amount of deviation of the air/fuel ratio of the cylinder. Thus, the revolution time difference ΔT of each cylinder can be used as an index value indicating the revolution fluctuation regarding the cylinder, that is, the revolution fluctuation amount regarding the cylinder. As the air/fuel ratio deviation amount of each cylinder is greater, the revolution fluctuation regarding the cylinder is greater and the revolution time difference ΔT of the cylinder is greater.

On the other hand, during the normal state, the revolution time difference ΔT of each cylinder is constantly in the vicinity of zero as shown in the portion (C) in FIG. 3.

Although the example shown in FIG. 3 illustrates the case of lean deviation abnormality, a similar tendency also occurs in the opposite case, that is, the case of rich deviation abnormality, that is, the case where only one cylinder has a large rich deviation. If a large rich deviation occurs, ignition brings about insufficient combustion due to the excessive fuel, so that sufficient torque cannot be obtained and the revolution fluctuation becomes large.

Next, with reference to FIG. 4, a different value that represents the revolution fluctuation, that is, another example of the revolution fluctuation amount, will be described. A portion (A) in FIG. 4, similar to the portion (A) in FIG. 3, shows the crank angle (° CA) of the engine.

A portion (B) in FIG. 4 shows the angular velocity ω (rad/s), which is a reciprocal of the revolution time T. That is, ω=1/T. Naturally, as the angular velocity ω is larger, the engine revolution speed is higher, and as the angular velocity ω is smaller, the engine revolution speed is lower. The waveform of the angular velocity ω is a form obtained by inverting the waveform of the revolution time T upside down.

A portion (C) in FIG. 4 shows the angular velocity difference Δω that is a difference in the angular velocity ω, similar to the revolution time difference ΔT that is the difference in the revolution time. The waveform of the angular velocity difference Δω is also a form obtained by inverting the waveform of the revolution time difference ΔT upside down. The terms “NORMAL” and “LEAN DEVIATION ABNORMALITY” in FIG. 4 mean the same as those in FIG. 3.

Firstly, the angular velocity ω of each cylinder at the same timing is detected by the ECU. In this case, too, the angular velocity ω at the timing of the compression top dead center (TDC) of each cylinder is detected. The angular velocity ω is calculated by dividing 1 by the revolution time T.

Next, at every detection timing, a difference (ω2−ω1) between the angular velocity ω2 at the present detection timing and the angular velocity col at the immediately previous detection timing is calculated by the ECU. This difference is the angular velocity difference Δω shown in the portion (C) in FIG. 4, that is, Δω=ω2−ω1.

Usually, during the combustion stroke after the crank angle exceeds the TDC, the revolution speed rises and therefore the angular velocity ω rises, and during the subsequent compression stroke, the revolution speed decreases and therefore the angular velocity ω decreases.

However, as shown in the portion (B) in FIG. 4, if the #1 cylinder has a lean deviation abnormality, ignition of the #1 cylinder does not bring about sufficient torque and therefore the revolution speed does not easily rise, so that the angular velocity ω at the #3 cylinder's TDC is small. Hence, the angular velocity difference Δω at the #3 cylinder's TDC is a great negative value as shown in the portion (C) in FIG. 4. The angular velocity and the angular velocity difference at the #3 cylinder's TDC are defined as the angular velocity and the angular velocity difference of the #1 cylinder, and are represented by ω₁ and Δω₁, respectively. This applies to the other cylinders as well.

Next, when the #3 cylinder is ignited, the revolution speed sharply rises since the #3 cylinder is normal. This results in a slight increase in the angular velocity ω at the time of the #4 cylinder's TDC in comparison with the angular velocity ω detected at the #3 cylinder's TDC. Therefore, the revolution time difference Δωₐ of the #3 cylinder detected at the #4 cylinder's TDC is a small positive value as shown in the portion (C) in FIG. 4. Thus, at every ignition cylinder's TDC, the angular velocity difference Δω of a cylinder is detected.

After that, a tendency similar to that observed at the #4 cylinder's TDC is observed at the #2 cylinder's TDC and the #1 cylinder's TDC as well, and the angular velocity difference Δω₄ of the #4 cylinder and the angular velocity difference Δω₂ of the #2 cylinder detected at the two TDC timings are both small positive values. The above-described characteristic is repeated every engine cycle.

Thus, it should be understood that the angular velocity difference Δω of each cylinder is a value that represents the revolution fluctuation regarding the cylinder, and that correlates with the amount of deviation of the air/fuel ratio in the cylinder. Thus, the angular velocity difference Δω of each cylinder may be used as an index value indicating the revolution fluctuation regarding the cylinder. As the air/fuel ratio deviation amount of each cylinder is greater, the revolution fluctuation regarding the cylinder is greater and the angular velocity difference Δω of the cylinder is smaller (i.e., the angular velocity difference Δω of the cylinder is greater in the negative (minus) direction).

On the other hand, during the normal state, the angular velocity difference Δω of each cylinder is constantly in the vicinity of zero as shown in the portion (C) in FIG. 4.

In the case of rich deviation abnormality, which is opposite to the above-described case, there is a similar tendency as mentioned above.

Next, the change in the revolution fluctuation amount that occurs when the fuel injection amount of a cylinder is actively increased or decreased, that is, is forced to increase or decrease, so as to change the air/fuel ratio of the cylinder will be described with reference to a conceptual diagram shown in FIG. 5. In this case, however, when the fuel injection amount is actively increased or decreased, the operation of the throttle valve 12 and the like are controlled so that the intake air amount is not changed.

In FIG. 5, the horizontal axis shows the imbalance rate IB, and the vertical axis shows the revolution fluctuation amount. In this example shown in FIG. 5, a line L1 indicates a relation between the revolution fluctuation amount regarding only a certain one of the total of eight cylinders and the imbalance rate IB of the certain cylinder obtained when the imbalance rate IB of the certain cylinder is changed by increasing or decreasing the fuel injection amount thereof. The certain cylinder is termed the active-change-object cylinder. It is assumed that all the other cylinders are balance cylinders, and fuel in the stoichiometric ratio-corresponding amount (i.e., the amount corresponding to the stoichiometric ratio), which is a reference fuel injection amount, is injected for all the other cylinders.

Although in FIG. 5, the imbalance rate is adopted on the horizontal axis, the air/fuel ratio may also be used on the horizontal axis instead of the imbalance rate. In FIG. 5, toward the left side along the horizontal axis, the imbalance rate becomes greater in the positive (plus) direction. Correspondingly, in the case where the air/fuel ratio is used instead of the imbalance rate, the air/fuel ratio becomes richer toward the left side in the diagram.

The horizontal axis in FIG. 5 represents the imbalance rate IB. In FIG. 5, as the imbalance rate IB shifts toward the left side from a line S indicating the imbalance rate IB of 0% that is the imbalance rate when the fuel injection amount of the active-change-object cylinder is equal to the stoichiometric ratio-corresponding amount, the imbalance rate IB increases in the positive direction, and the fuel injection amount changes to an excessively large amount, that is, the air-fuel ratio becomes rich. Conversely, as the imbalance rate IB shifts rightward from the line S indicating the imbalance rate IB of 0%, the imbalance rate IB increases in the negative direction (i.e., decreases), and the fuel injection amount changes to an excessively small amount, that is, the air-fuel ratio becomes lean. Besides, in FIG. 5, the revolution fluctuation amount becomes greater toward the upper side.

As can be understood from the characteristic line L1 in FIG. 5, the revolution fluctuation amount regarding the active-change-object cylinder tends to become larger as the imbalance rate IB of the active-change-object cylinder increases from 0% no matter whether it increases in the positive or negative direction. There is also a tendency that as the imbalance rate IB becomes farther away from 0%, the slope of the characteristic line L1 becomes steeper, and the amount of change or the rate of change in the revolution fluctuation amount relative to the amount of change or the rate of change in the imbalance rate IB becomes greater.

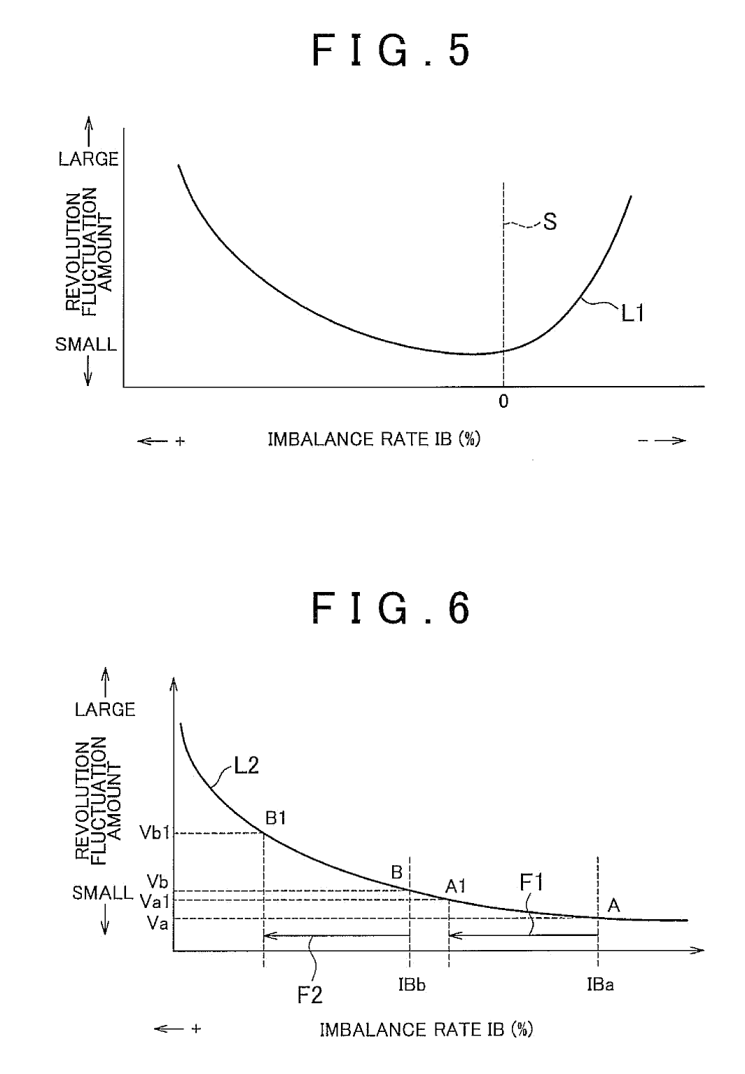

FIG. 6 shows a partial region in the diagram of FIG. 5 in which the imbalance rate IB is plus in sign. A line L2 in FIG. 6 is equivalent to a portion of the line L1 in FIG. 5.

FIG. 6 shows two examples of the imbalance rate IB of the active-change-object cylinder by line segments A and B. The imbalance rate IBa on the line segment A is an example of the imbalance rate that is deviated in the positive direction from the imbalance rate of 0% (see the line S in FIG. 5), which is the stoichiometric ratio-corresponding value, and that is within a permissible range. On the other hand, the imbalance rate IBb on the line segment B is an example of the imbalance rate that is deviated from the imbalance rate IBa on the line segment A in the direction in which the fuel injection amount becomes larger, and that is outside the permissible range.

Hereinafter, the case where the state of the active-change-object cylinder when the stoichiometric ratio control is being executed during usual operation is a state on the line segment A will be considered. It is assumed that at this time, the fuel injection amount of the active-change-object cylinder is forced to increase by a predetermined amount Δf1, as shown by an arrow F1. The predetermined amount Δf1 may be arbitrarily set, and may be, for example, an amount that corresponds to about 40% in the imbalance rate. The slope of the characteristic line L2 is gentle in the vicinity of IB=0% (near the right-side end in FIG. 6). Therefore, in the case where the state of the active-change-object cylinder during execution of the stoichiometric control is the state on the line segment A, the revolution fluctuation amount Va1 during the state on the line segment A1 that is obtained by increasing the fuel injection amount by the predetermined amount Δf1 is not substantially different from the revolution fluctuation amount Va occurring prior to the increase of the fuel injection amount.

The case where the state of the active-change-object cylinder during execution of the stoichiometric control is a state on the line segment B will be considered. In this case, the active-change-object cylinder already has a rich deviation that exceeds the permissible range, and the imbalance rate IBb thereof is relatively large value on the plus side. For example, the imbalance rate IBb on the line segment B corresponds to a rich deviation that corresponds to the imbalance rate of about 60%. If from this state, the fuel injection amount of the active-change-object cylinder is forced to increase by the predetermined amount Δf1 as indicated by an arrow F2, the post-increase revolution fluctuation amount Vb1 is considerably larger than the pre-increase revolution fluctuation amount Vb, that is, the difference in the revolution fluctuation amount (Vb1−Vb) between before and after the increase of the fuel injection amount is large, since the slope of the characteristic line L2 is steep in a region including the line segment B1 that is the segment after the fuel injection amount of the active-change-object cylinder is forced to increase. That is, the increase of the fuel injection amount as described above sufficiently increases the revolution fluctuation regarding the active-change-object cylinder.

Hence, imbalance abnormality can be detected on the basis of at least the post-increase revolution fluctuation amount regarding the active-change-object cylinder, which is obtained after the fuel injection amount of the active-change-object cylinder is forced to increase by a predetermined amount. For example, if the magnitude of the post-increase revolution fluctuation amount (e.g., |Vb1|) is larger than a predetermined value, it can be determined that there is imbalance abnormality. Furthermore, it may be determined whether there is inter-cylinder air/fuel ratio imbalance abnormality by comparing a predetermined value and an average value of the revolution fluctuation amounts regarding the active-change-object cylinder, which are obtained during a plurality of cycles, or a statistically processed value of the revolution fluctuation amounts regarding the active-change-object cylinder, which are obtained during a plurality of cycles. Thus, when the inter-cylinder air/fuel ratio imbalance abnormality is present, the inter-cylinder air/fuel ratio imbalance abnormality can be conspicuously reflected in the fuel in the combustion chamber, that is, the state of combustion of the mixture therein, by increasing the fuel injection amount, and the result of the conspicuous reflection is detected as a revolution fluctuation amount, so that the imbalance abnormality can be detected on the basis of the detected revolution fluctuation amount.

In the above-described example, the imbalance abnormality is detected by performing a control of forcing the fuel injection amount to increase by a predetermined amount (a fuel injection amount increase control). This is effective when the fuel injection amount of the imbalance cylinder is deviated to the greater amount side.

Conversely, if the fuel injection amount of the imbalance cylinder is deviated to the smaller amount side, it is effective to detect the imbalance abnormality by performing a control of forcing the fuel injection amount to decrease by a predetermined amount Δf2 (a fuel injection amount decrease control). The case where the fuel injection amount is forced to decrease in a region where the imbalance rate is negative is understandable from the above-described case, and will not be described below. However, it is appropriate that the amount (magnitude) of decrease Δf2 in the fuel injection amount decrease control be smaller than the amount (magnitude) of increase Δf1 in the fuel injection amount increase control. This is because if the fuel injection amount for the cylinder having the lean deviation abnormality is excessively decreased, there is a possibility that a misfire may occur. The predetermined amount Δf2 of decrease may be arbitrarily set, and may be, for example, an amount of decrease that corresponds to about 10% in the imbalance rate. The aforementioned predetermined value that is a threshold value for detecting the imbalance abnormality in the fuel injection amount increase control and a predetermined value that is a threshold value for detecting the imbalance abnormality in the fuel injection amount decrease control may be the same or may be different from each other.

The fuel injection amount increase control and the fuel injection amount decrease control can be applied simultaneously to all the cylinders in a uniform manner, in which case predetermined object cylinders are all the cylinders. However, in this embodiment, the fuel injection amount change control is not applied simultaneously to all the cylinders in a uniform manner, but is applied to at least one predetermined object cylinder at a time, and the object cylinder to which the fuel injection amount change control is applied is sequentially changed to another cylinder. That is, examples of the method of applying the fuel injection amount change control include a method in which the control is performed simultaneously for all the cylinders, and a method in which the control is performed for groups of arbitrary numbers of cylinders sequentially and alternately. For example, there are methods in which the fuel injection amount is increased for one cylinder at a time, or increased for two cylinders at a time, or increased for four cylinders at a time. The number of object cylinders and the cylinder numbers assigned to the object cylinders for which the fuel injection amount is forced to increase or decrease can be arbitrarily set.

As described above, in order to detect the inter-cylinder air/fuel ratio imbalance abnormality, it is effective to increase the revolution fluctuation amount corresponding to the imbalance rate by performing the control of forcing the fuel injection amount to increase or decrease, that is, the fuel injection amount change control. Then, with regard to the fuel injection amount change control, it is desired that the amount of increase or decrease of the fuel injection amount be made larger so as to make it possible to more clearly detect the imbalance abnormality, if it is present. However, if the amount of increase or decrease of the fuel injection amount is made excessively large, the drivability may deteriorate due to occurrence of vibration, or the exhaust emission may deteriorate. Therefore, it is desired to reduce the control amount of the fuel injection amount change control while preventing deterioration of the drivability and deterioration of the exhaust emission as much as possible.

In order to appropriately detect the inter-cylinder air/fuel ratio imbalance abnormality while reducing the control amount of the fuel injection amount change control, a control of retarding the ignition timing (ignition retardation control) is executed along with the fuel injection amount change control. In general, by retarding the ignition timing, the torque produced by the object cylinder can be reduced. Therefore, by decreasing the produced torque, revolution fluctuation that occurs on the basis of the fuel injection amount change control can be made conspicuous. That is, by performing the ignition timing retardation control for a predetermined object cylinder along with the fuel injection amount change control, it is possible to increase the revolution fluctuation amount that is caused by the output produced by the cylinder that brings about the inter-cylinder air/fuel ratio imbalance abnormality. Moreover, by applying the ignition timing retardation control, it is possible to reduce the amount of increase in the fuel amount in the fuel injection amount increase control, and therefore it is possible to improve the fuel economy.

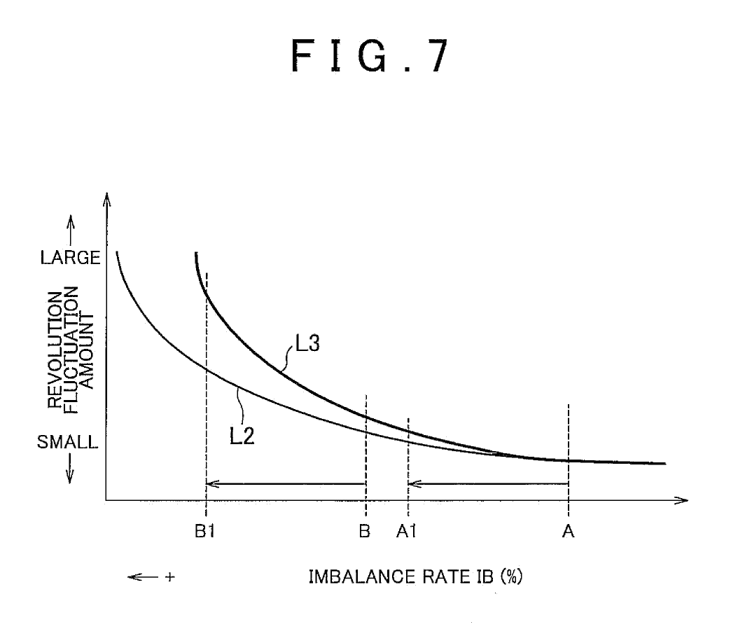

In FIG. 7, a line L3 conceptually shows changes in the revolution fluctuation amount relative to the imbalance rate IB in the case where the ignition timing retardation control is applied. FIG. 7 also shows the line L2 shown in FIG. 6. As is apparent from the line L3 in FIG. 7, by executing the ignition timing retardation control and the fuel injection amount change control in combination, it is possible to increase the amount of change or the rate of change in the revolution fluctuation amount relative to the amount of change or the rate of change in the imbalance rate IB. Hence, by performing the ignition timing retardation control while reducing the amount of increase or decrease in the fuel amount in the fuel injection amount change control, it becomes possible to acquire a large revolution fluctuation amount if the inter-cylinder air/fuel ratio imbalance abnormality is present.

The amount of ignition timing retardation in the ignition timing retardation control performed together with the fuel injection amount change control can be set at a predetermined amount, and the predetermined amount can be arbitrarily set. For example, the predetermined amount can be set at the crank angle of 10°. Accordingly, the amount of increase in the fuel injection amount in the fuel injection amount change control can be reduced from, for example, the amount of fuel that corresponds to about 40% in the imbalance rate, to three quarters of the amount of fuel, a half thereof, etc., and the amount of decrease in the fuel injection amount can be reduced from, for example, the amount of fuel that corresponds to about 10% in the imbalance rate, to three quarters of the amount of fuel, a half thereof, etc. The invention allows merely combining the ignition timing retardation control with the fuel injection amount change control using the aforementioned amount of increase or decrease.

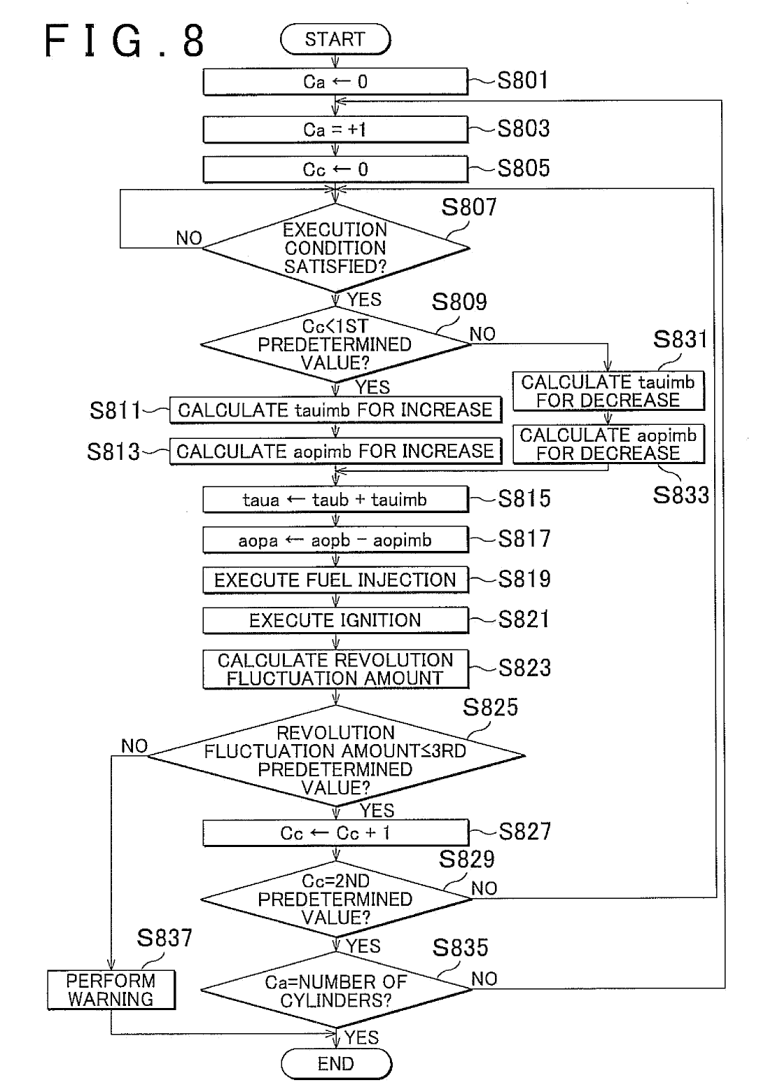

Hereinafter, a control of detecting the presence or absence of the inter-cylinder air/fuel ratio imbalance abnormality by performing the ignition timing retardation control together with the fuel injection amount change control of making the fuel injection amount greater or less than the usual fuel injection amount used in the usual fuel injection control, that is, an air/fuel ratio diagnostic control in the first embodiment of the invention, will be described with reference to a flowchart shown in FIG. 8.

After the engine 1 is started, an object cylinder counter Ca is reset to zero in step S801. The object cylinder counter Ca is a counter that indicates the cylinder number of a cylinder that is an object for which the aforementioned air/fuel ratio diagnostic control is performed, that is, an (active-change) object cylinder. In step S803, the object cylinder counter Ca is incremented by 1. Subsequently in step S805, an execution cycle counter Cc is reset to zero.

Then in step S807, it is determined whether a predetermined condition for executing the air/fuel ratio diagnostic control has been satisfied. In this example, the predetermined condition is a condition that the engine be in a predetermined (operation) state after the starting of the engine. Various conditions may be set as the predetermined condition. For example, the predetermined condition may be satisfaction of all of: a condition that the engine coolant temperature be greater than or equal to a predetermined temperature (e.g., 70° C.); a condition that the load be within a predetermined range (e.g., the intake air amount be within a predetermined range of the intake air amount (e.g., 15 to 50 Ws)); and a condition that the engine revolution speed be in a predetermined engine revolution speed range (e.g., 1500 rpm to 2000 rpm).

When the predetermined condition has been satisfied, the air/fuel ratio feedback control is usually executed so that the exhaust air/fuel ratio becomes equal to the stoichiometric ratio, in order to more suitably perform the exhaust control using the catalytic converters 18 and 19 as mentioned above. Therefore, the determination in step S807 corresponds to determination as to whether the air/fuel ratio control is being executed so as to make the exhaust air/fuel ratio equal to a predetermined target air/fuel ratio, and it is to be noted that the predetermined target air/fuel ratio in this case is the stoichiometric ratio. However, the predetermined target air/fuel ratio may be other than the stoichiometric ratio. In the invention, the predetermined condition may include but does not necessarily need to include a condition that the foregoing air/fuel ratio control is being performed.

If an affirmative determination is made in step S807, it is determined in step S809 whether the execution cycle counter Cc is less than a first predetermined value. The first predetermined value is set at 1 in this example. However, the first predetermined value may be set at an arbitrary integer that is equal to or greater than 1. The first predetermined value is smaller than a second predetermined value described later.

If the execution cycle counter Cc is less than the first predetermined value, and therefore, an affirmative determination is made in step S809, an amount of change tauimb in the fuel injection amount is calculated in step S811. Herein, the amount of change tauimb as a predetermined amount for increasing the fuel injection amount is calculated. The amount of change tauimb is calculated by searching through the data for increasing the fuel injection amount, which is stored beforehand in a storage device, on the basis of the engine revolution speed and the engine load. The amount of change tauimb may be calculated by performing a predetermined computation based on a predetermined expression.

Subsequently in step S813, an amount of change aopimb in the ignition timing is calculated. The amount of change aopimb is calculated by searching through the data for increasing the fuel injection amount, which is stored beforehand in the storage device, on the basis of the engine revolution speed and the engine load. The amount of change aopimb may be calculated by performing a predetermined computation based on a predetermined expression.

Then in step S815, the amount of change tauimb calculated in step S811 is added to the fuel injection amount calculated for a basic control (i.e., a usual control), that is, the usual-time fuel injection amount taub, whereby a fuel injection amount taua in the fuel injection amount change control is determined. The usual-time fuel injection amount taub is the stoichiometric ratio-corresponding amount.

Next in step S817, the amount of change aopimb in the ignition timing calculated in step S813 is applied to the ignition timing determined as described above for use in the basic control (i.e., in the usual control), that is, a usual-time ignition timing aopb. Thus, an ignition timing aopa in the ignition timing retardation control, which is obtained by retarding the ignition timing by the amount of change aopimb, is determined.

Then in step S819, the amount taua of the fuel calculated in step S815 is injected from the fuel injection valve 2 of the object cylinder. For this injection, in step S821, the operation of the ignition plug 13 of the object cylinder is controlled so that the ignition is performed at the ignition timing aopa calculated in step S817.

Thus, the revolution fluctuation amount obtained when the fuel injection amount change control and the ignition timing retardation control are executed is calculated on the basis of the output of the crank angle sensor 22 in step S823. It is determined in S825 whether the revolution fluctuation amount calculated in step S823 is less than or equal to a third predetermined value. The third predetermined value is determined beforehand for the purpose of detecting the inter-cylinder air/fuel ratio imbalance abnormality, and the revolution fluctuation amount up to the third predetermined value is permitted in the engine 1.

If the revolution fluctuation amount is less than or equal to the third predetermined value, and therefore, an affirmative determination is made in step S825, 1 is added to the execution cycle counter Cc in step S827. Subsequently in step S829, it is determined whether the execution cycle counter Cc is equal to a second predetermined value that is greater than the first predetermined value. The second predetermined value in this example is set at 2, but may be set at an arbitrary integer that is greater than or equal to 2. It is to be noted herein that, for example, in the case where a control step (described later) of forcing the fuel injection amount to decrease is omitted from the control shown in FIG. 8, the second predetermined value can be set at an arbitrary integer that is greater than or equal to 1.

If the execution cycle counter Cc is not equal to the second predetermined value, and therefore, a negative determination is made in step S829, the process returns to step S807, so that the diagnostic control is repeated.

Subsequently in step S809, a negative determination is made since the execution cycle counter Cc is 1, and therefore is not less than the first predetermined value. Then, the process proceeds to step S831. In step S831, the amount of change tauimb in the fuel injection amount is calculated. In step S831, the amount of change tauimb is calculated as a predetermined amount for decreasing the fuel injection amount, unlike step S811 described above. The amount of change tauimb is calculated by searching through the data for decreasing the fuel injection amount, which is stored beforehand in the storage device, on the basis of the engine revolution speed and the engine load. The amount of change tauimb may be calculated by performing a predetermined computation based on a predetermined expression.

Subsequently in step S833, the amount of change aopimb in the ignition timing is calculated. The amount of change aopimb is calculated by searching through the data for decreasing the fuel injection amount, which is stored beforehand in the storage device, on the basis of the engine revolution speed and the engine load. The amount of change aopimb may be calculated by performing a predetermined computation based on a predetermined expression.

After step S833, the process proceeds to step S815. Then, the above-described computations and controls in steps S815 to S823 are executed. It is determined in step S825 whether the revolution fluctuation amount calculated in step S823 is less than or equal to the third predetermined value. The third predetermined value may be changed between when the fuel injection amount is increased after step S811 is performed and when the fuel injection amount is decreased after step S831 is performed. If in step S825, it is determined that the revolution fluctuation amount is less than or equal to the third predetermined value, 1 is added to the execution cycle counter Cc, so that the counter Cc becomes equal to 2 in step S827. Then, in step S829, it is determined whether the execution cycle counter Cc is equal to the second predetermined value. Since the second predetermined value is set at 2 in this example, an affirmative determination is made in step S829.

After an affirmative determination is made in step S829, it is subsequently determined in step S835 whether the object cylinder counter Ca is equal to the number of the cylinders. The determination in step S835 corresponds to determination as to whether the computations and controls in step S807 to S833 have been performed for all the cylinders. In this example, the number of the cylinders is 8.

If in step S835, the object cylinder counter Ca is not equal to the number of the cylinders, and therefore, a negative determination is made, the process proceeds to step S803, in which 1 is added to the object cylinder counter Ca. Subsequently in step S805, the execution cycle counter Cc is reset to zero. Then, the process proceeds to step S807.

When the computations and controls in step S807 to S833, that is, the diagnostic control steps, have been repeated for all the cylinders and therefore in step S835 an affirmative determination is made, that is, it is determined that the object cylinder counter Ca is equal to the number of the cylinders, the diagnostic control is ended. In this example, the diagnostic control shown in FIG. 8 is performed only once after the engine 1 is started. However, this diagnostic control may be executed at appropriate timing. For example, the diagnostic control can be executed when the operation time of the engine 1 or the travel distance of the vehicle including the engine 1 becomes equal to a predetermined value.

On the other hand, if the revolution fluctuation amount is greater than the third predetermined value, and therefore, a negative determination is made in step S825, the process proceeds to step S837, in which, for example, a warning lamp provided in a front panel at the driver's seat side is turned on in order to inform the driver that the inter-cylinder air/fuel ratio imbalance abnormality has been detected. This ends the diagnostic control shown in FIG. 8.

Although in this embodiment the diagnostic control shown in FIG. 8 is ended if the imbalance abnormality is detected with any one of the cylinders, the flow shown in FIG. 8 can be reconstructed so that the diagnostic control is always performed for all the cylinders in order to specifically determine a cylinder(s) that bring(s) about the inter-cylinder air/fuel ratio imbalance abnormality.

Next, a second embodiment of the invention will be described. The construction of an engine to which the second embodiment is applied is substantially the same as that of the engine 1 to which the first embodiment is applied. Therefore, in the following description, component elements of the engine to which the second embodiment is applied will not be described. In the engine to which the second embodiment is applied, a control for detecting the inter-cylinder air/fuel ratio imbalance abnormality, which is a combination of the fuel injection amount change control and the ignition timing retardation control, is executed, similarly to the engine 1 described above. However, in the second embodiment, the ignition timing retardation control is not forced to be executed for the diagnostic purpose, but the fuel injection amount change control is forced to be executed when the ignition timing retardation control is being executed. Thus, the presence or absence of the inter-cylinder air/fuel ratio imbalance abnormality can be determined.

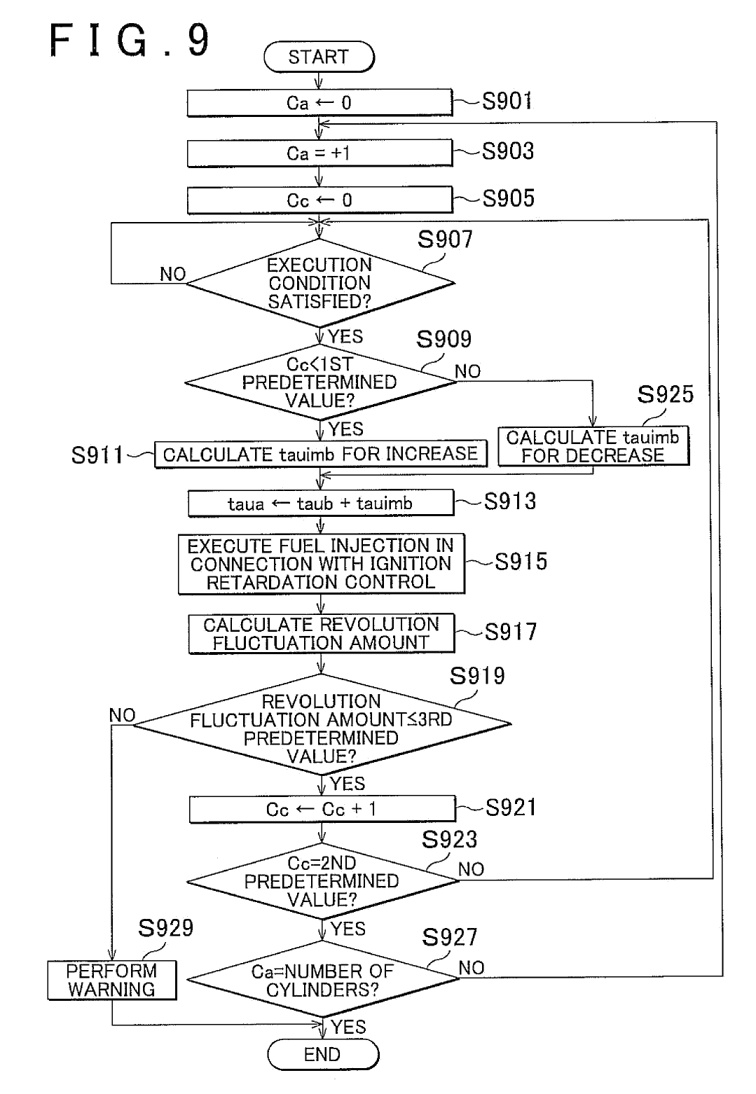

Hereinafter, an air/fuel ratio diagnostic control in the second embodiment of the invention will be described with reference to a flowchart shown in FIG. 9. The processes of steps S901 to S905, S909 and S911 to S929 shown in FIG. 9 correspond to steps S801 to S805, S809, S811, S815, S819, S823 to S831, S835 and S837, and therefore, the descriptions thereof are substantially omitted.

In step S907, as in step S807, it is determined whether a predetermined condition for executing the air/fuel ratio diagnostic control has been satisfied. A condition that the engine be in a predetermined state after starting of the engine is set as the predetermined condition. For example, a condition that the ignition timing retardation control of retarding the ignition timing by a predetermined amount be being executed can be set as the predetermined condition, or can be included within the predetermination condition. For example, when the ignition timing retardation correction amount from the reference ignition timing, which is provided by the KCS (knock control system), is greater than 10°, it can be determined that the condition that the ignition timing retardation control of retarding the ignition timing by a predetermined amount be being executed is satisfied. It can also be determined that this condition is satisfied, when the ignition timing retardation control is being executed, on the basis of various control factors other than the control factors regarding knocking. The predetermined condition in step S907 may include all of or a part of the predetermined condition in step S807.

If an affirmative determination is made in step S907, the fuel injection amount change control is executed in step S909 and the subsequent steps. In step S915, the fuel injection amount change control is executed together with the ignition timing retardation control that has been recognized as being executed in step S907.

Although the invention has been described above with reference to the embodiments, the invention is not limited to the foregoing embodiments. The invention allows various combinations of the foregoing embodiments and their modifications without causing contradictions, and embodiments that include only a portion of the foregoing embodiments and their modifications. The invention is applicable to various type multi-cylinder engines that have two or more cylinders, and is also applicable to not only port injection-type engines but also in-cylinder injection-type engines, engines that use a gas as a fuel, etc. Besides, the number of cylinders, the type of cylinder arrangement, etc., of an engine to which the invention is applied is arbitrary.

In the foregoing embodiments, the revolution fluctuation amount is used to determine or evaluate the output fluctuation. However, other values or quantities may be used. For example, an in-cylinder pressure sensor may be provided for each cylinder, and the output fluctuation may be determined on the basis of the outputs of the in-cylinder sensors. Alternatively, a device (sensor) constructed to detect ion current that occurs in connection with the combustion of a mixture in the combustion chamber of each cylinder of an internal combustion engine may be provided, and the output fluctuation may be determined on the basis of the ion output detected by the device.

The invention is not limited to the foregoing embodiments, and the invention includes all modifications, application examples and equivalents encompassed in the scope of the invention that is defined by the claims. Therefore, the invention is not to be interpreted in a limited manner, but is applicable to other arbitrary technologies that belong to the scope of the invention.

What is claimed is:

1. An inter-cylinder air/fuel ratio imbalance abnormality detection apparatus for a multicylinder internal combustion engine, comprising:
a fuel injection amount change control portion that executes a fuel injection amount change control of forcing a fuel injection amount of a predetermined object cylinder to change by a predetermined amount;
an ignition timing retardation control portion that executes an ignition timing retardation control for the predetermined object cylinder; and
a detection portion that detects an inter-cylinder air/fuel ratio imbalance abnormality based on output fluctuation regarding the predetermined object cylinder occurring when the fuel injection amount change control and the ignition timing retardation control are executed together for the predetermined object cylinder.

2. The inter-cylinder air/fuel ratio imbalance abnormality detection apparatus according to claim 1, wherein the fuel injection amount change control portion executes the fuel injection amount change control so that the fuel injection amount of the predetermined object cylinder is increased or decreased from a usual-time fuel injection amount by the predetermined amount.

3. The inter-cylinder air/fuel ratio imbalance abnormality detection apparatus according to claim 1, wherein the detection portion detects the inter-cylinder air/fuel ratio imbalance abnormality based on revolution fluctuation regarding the predetermined object cylinder occurring when the fuel injection amount change control and the ignition timing retardation control are executed together for the predetermined object cylinder.

4. The inter-cylinder air/fuel ratio imbalance abnormality detection apparatus according to claim 1, wherein when the ignition timing retardation control portion is executing the ignition timing retardation control, the fuel injection amount change control portion starts the fuel injection amount change control so that the fuel injection amount change control and the ignition timing retardation control are executed together.

5. An inter-cylinder air/fuel ratio imbalance abnormality detection method for a multicylinder internal combustion engine, comprising:
executing a fuel injection amount change control of forcing a fuel injection amount of a predetermined object cylinder to change by a predetermined amount;
executing an ignition timing retardation control for the predetermined object cylinder; and
detecting an inter-cylinder air/fuel ratio imbalance abnormality based on output fluctuation regarding the predetermined object cylinder occurring when the fuel injection amount change control and the ignition timing retardation control are executed together for the predetermined object cylinder.

6. The inter-cylinder air/fuel ratio imbalance abnormality detection method according to claim 5, wherein the fuel injection amount change control is executed so that the fuel injection amount of the predetermined object cylinder is increased or decreased from a usual-time fuel injection amount by the predetermined amount.

7. The inter-cylinder air/fuel ratio imbalance abnormality detection method according to claim 5, wherein the inter-cylinder air/fuel ratio imbalance abnormality is detected based on revolution fluctuation regarding the predetermined object cylinder occurring when the fuel injection amount change control and the ignition timing retardation control are executed together for the predetermined object cylinder.

8. The inter-cylinder air/fuel ratio imbalance abnormality detection method according to claim 5, further comprising
determining whether the ignition timing retardation control is being executed, wherein if it is determined that the ignition timing retardation control is being executed, the fuel injection amount change control is started so that the fuel injection amount change control and the ignition timing retardation control are executed together.
